(19) United States
(12) Patent Application Publication
(10) Pub. No.: US 2008/0052845 A1
(43) Pub. Date: Mar. 6, 2008

(54) CYLINDRICAL DUAL ROTATING ELECTRIC TOOTHBRUSH

(76) Inventor: Sam S. Djang, North Hills, CA (US)

Correspondence Address: GEORGE R. REARDON, 3356 STATION COURT, LAWRENCVILLE, GA, 30044, US

(21) Appl. No.: 11/850,388

(22) Filed: Sep. 5, 2007

Related U.S. Application Data
(60) Provisional application No. 60/842,411, filed on Sep. 5, 2006.

(51) Int. Cl. A61C 17/26; A46D 3/00

(52) U.S. Cl. 15/23; 300/21

(57) ABSTRACT

A powered, mechanical teeth cleaning device having two lines of rotating brushes is disclosed. The brushes rotate inwardly from each side, giving a cleaning effect on both buccal and lingual surface of the tooth from the gum tissue to the tooth direction. A protective shield for minimizing tissue irritation, a guiding stop for proper tooth positioning and a brush direction-of-rotation switch are included.

This application claims the benefit of the filing date of U.S. Provisional Patent Application 60/842,411 filed on Sep. 5, 2006, which is incorporated herein in its entirety.

### FIELD OF THE INVENTION

The technology described herein relates to mechanical teeth cleaning devices driven by electric or non-electric power and methods of making and using thereof.

In general the technology described herein relates to the fields of mouth hygiene and dental care, in particular for humans, but it may be adapted for veterinary use.

### BACKGROUND OF THE INVENTION

For a long time specialists have been agreed that in order to be really effective, teeth must be brushed from the gum towards the end of the tooth, i.e. downwards for the top jaw and upwards for the bottom jaw.

It has been a long standing need to make a perfect tooth cleaning device in dentistry. Most of dental decays and gum problems start from the area called embrasure, that is the space between the two adjacent teeth and gum line. Present manual and electrical toothbrushes can not reach these areas very efficiently. In addition, brushing direction is important to protect the gum line form receding. To achieve this goal, the brushing direction should be long-axis of the tooth and at the same time, it should be directed from the gum tissue towards the direction of the target tooth. In the present market, there are some toothbrushes manufactured based on this concept. However, since the designers of these toothbrushes apparently ignored major or minor structural parts or system in their designs, their products can lead to one or more secondary problems or can never reach the intended goal.

Related art that addresses this and other problems includes the following patents.

U.S. Pat. No. 5,864,911, issued to Arnoux et al. on Feb. 2, 1999 discloses a mechanical toothbrush with a dual rotary brushing system and comprising a handle-forming body and a head fixed to the handle, which head is provided with two adjacent contra-rotating brushes of cylindrical shape and having substantially parallel axes. Each of the two brushes is driven by a flexible shaft situated in the head and supported, at least at its distal end, by a respective bearing mounted on a support that enables the two brushes to move apart one away from the other, then urging the brushes towards the other by a return effect.

U.S. Pat. No. 2,628,377, issued to Cockriel on Feb. 17, 1953 discloses a mechanical toothbrush having rotary brushes.

U.S. Pat. No. 2,758,326, issued to Keely et al. on Aug. 14, 1956 discloses a power driven rotary toothbrush which enables the user to reach without difficulty the teeth least accessible, i.e., the back molars, and which subjects the teeth to gentle yet effective and approved cleaning action.

U.S. Pat. No. 4,313,237, issued to Smith on Feb. 2, 1982 discloses an improved driven rotary toothbrush having an electric motor enclosed in a handle and driving a plurality of rotary brushes for simultaneously cleaning multiple tooth surfaces. The rotary brushes are mounted in a brush head adapted to be releasably supported on one end of an elongated brush head support stem having flexible drive shafts extending therealong and having its other end adapted to be releasably mounted on the handle to provide rotary driven connection between the motor and brushes. The releasable mounting of the brush head and of the support stem enables hygienic use of the same motor and handle by a plurality of persons through use of personalized snap-on brush heads and support stems, and also makes possible the easy and economical replacement of the brush heads.

U.S. Pat. No. 5,027,463, issued to Daub on Jul. 2, 1991 discloses a toothbrush for use in simultaneously brushing and cleaning the occlusal, lingual and buccal surfaces of the upper and lower teeth of a user. The toothbrush, in the preferred embodiment, is power-driven and includes bristle support member which anchors bristles from opposite surfaces thereof. The bristles are arranged in longitudinal rows including central rows, intermediate rows and outer rows. The central rows are straight while the intermediate and outer rows are curved for engaging the lingual and buccal surfaces. The bristles are shaped and arranged in a heating chamber while being anchored to the bristle support member.

U.S. Pat. No. 5,177,827, issued to Ellison on Jan. 12, 1993 discloses a simplified single-procedure approach to self-administered dental-care, achieved through means of a special hand-portable/battery-powered instrument, having a rechargeable-battery and a motor with gear-reduction contained within the handle portion. While preferably detachably-mounted thereto is a special extensile bifurcated structure, provided with lateral adjustability by which to accommodate variations in individual mouth width, while supporting a plurality of motor-driven rotary-brush elements capable of uniformly scrubbing all of the mouth's teeth, away from the gums, inside and out, in a simultaneous single motion fully-automated manner. Hence, the notion of a manually inserted, selectively actuated oral instrument, serving to brush clean the entire inside mouth surfaces of the gums, teeth, and adjoining cheek and tongue surfaces in a rapid simultaneous manner being a substantial advancement, efficiently eliminating reliance upon one's own manual dexterity for effectual daily oral-hygiene.

U.S. Pat. No. 6,625,834, issued to Dean on Sep. 30, 2003 discloses a preferably non-electric, non-mechanically actuated toothbrush is provided having a generally U-shaped appearance with a rotary brush located, during use, on each side of a tooth to be cleaned. The brushes are configured to rotate about an axis which is parallel to the long axis of the tooth to be cleaned, and essentially perpendicular to the buccal and lingual gum line, of the user. The brushes are preferably held in contact with the teeth and gum tissue by a resilient section of the toothbrush. In this fashion, a pushing and pulling motion during brushing results in a rotational motion of the brushes. An improved method for cleansing teeth, cleaning the opening to the gingival crevice area, and stimulation of the gingival tissue is provided.

While these patents and other previous methods have attempted to solve the problems that they addressed, none have utilized or disclosed a protective shield directed to addressing soft tissue irritation, oral cavity malignancies and splashing, and/or a guiding stop directed to proper tooth positioning of the device, as does embodiments of the technology described herein.

Therefore, a need exists for a cylindrical dual rotating electric toothbrush with these attributes and functionalities. The cylindrical dual rotating electric toothbrush according to embodiments of the invention substantially departs from the conventional concepts and designs of the prior art. It can be appreciated that there exists a continuing need for a new and improved cylindrical dual rotating electric toothbrush which can be used commercially. In this regard, the technology described herein substantially fulfills these objectives.

The foregoing patent and other information reflect the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

The technology described herein is directed to an electric toothbrush having two lines of electrically powered rotating brushes, i.e., bristles, which protrude from the handle. The bristles rotate inwardly from each side, giving a brushing effect on both buccal and lingual surface of the tooth from the gum tissue to the tooth direction. Ideal brushing direction should be to the long axis of the tooth, at the same time it should be from the gum tissue to the tooth direction. In this manner, the most critical area in the tooth brushing, that is the embrasure-space between two adjacent teeth and the gum line, can be cleaned more effectively and at the same time gum tissue, or gingival can be saved from detachment or receding.

Some embodiments of this technology are directed to having:
1. Electrical sensors that direct tooth width are and automatically adjust the brushes for the width of the teeth.
2. A version adapted for pets and animals of all kinds.
3. A version adapted for children, teens, adults and elderly persons.

The technology described herein has two lines of rotating bristles driven by electric power, which come out from the body part of the brush longitudinally. When the user places and seats the head tip of the brush with the two parallel lines of wire with the bristles onto the occlusal or incisal surface of the tooth, each one of the lines of the bristles covers both buccal and lingual surface of the tooth respectively. Then, with electric power, the bristles rotate inwardly from each side, giving a brushing effect on both buccal and lingual surface of the tooth vertically from the gum tissue to the tooth direction. Unlike other similar designs, e.g. U.S. Pat. No. 5,864,911, there is a space or a gap between the two lines of the bristles, which can easily guide the user to position the toothbrush in correct way.

Different combinations of spacing and arrangement of the dual head may make a significant difference for the users. Since each tooth has different dimensional thickness or width of its own, the user will be advised to move the toothbrush a little bit bucco-lingual direction where needed. Or the user can push the switch on the body part of the brush to the front teeth side to make the two lines of bristles come closer, so that it can cover the bucco-lingually narrowed front teeth more closed, efficient position.

The technology described herein has a dual head supporting system or covering which other designs, e.g. U.S. Pat. No. 5,864,911, lacks. Without this covering, the user will suffer irritation of the soft tissue including inner wall of the cheek and lips. This repeated irritation can cause not only injury to the oral soft tissue but could cause malignancies in the oral cavity.

One advantage of the technology described herein is that the covering works as protective shield to stop or minimize the splashing out of saliva and/or toothpaste from a user's mouth, which could annoy them and eventually discourage them to keep on using it.

Another advantage of the technology described herein is a guiding stop, located at the most middle part of the head tip of the brush. This stop guides the user to the correct position for a tooth. Without this stop, the user has more chances of making a mistake in positioning the brush with or without being in front of a mirror.

Another advantage of the technology described herein is that it can be made economically.

Another advantage of the technology described herein is that it can be made from readily available materials.

Other objects, advantages and capabilities of the invention are apparent from the following description taken in conjunction with the accompanying drawings showing the preferred embodiment of the invention.

### BRIEF DESCRIPTION OF THE SEVERAL VIEWS OF THE DRAWINGS

The invention, together with further advantages thereof, may best be understood by reference to the following description of the simplest form of the invention, taken in conjunction with the accompanying drawings in which:

FIG. 1 illustrates a front plan view of a head assembly with the guiding stop in a horizontal position, according to an embodiment of the technology described herein.

FIG. 2 illustrates a front plan view of a head assembly with the guiding stop in a non-horizontal position, according to an embodiment of the technology described herein.

FIG. 3 illustrates a top perspective view of a cylindrical dual rotating electric toothbrush, according to an embodiment of the technology described herein.

FIG. 4 illustrates a bottom perspective view of a cylindrical dual rotating electric toothbrush, according to an embodiment of the technology described herein.

FIG. 5 illustrates a top plan view of a cylindrical dual rotating electric toothbrush, according to an embodiment of the technology described herein.

FIG. 6 illustrates a side plan view of a cylindrical dual rotating electric toothbrush, according to an embodiment of the technology described herein.

FIG. 7 illustrates a bottom perspective view of a cylindrical dual rotating electric toothbrush, according to a second embodiment of the technology described herein.

FIG. 8 illustrates a bottom exploded view of a cylindrical dual rotating electric toothbrush, according to a second embodiment of the technology described herein.

FIG. 9 illustrates a top exploded view of a cylindrical dual rotating electric toothbrush, according to a second embodiment of the technology described herein.

FIG. 10 illustrates a rear perspective view of a cylindrical dual rotating electric toothbrush, according to an embodiment of the technology described herein.

FIG. 11 illustrates a front perspective view of a cylindrical dual rotating electric toothbrush, according to an embodiment of the technology described herein.

FIG. 12 illustrates a back exploded view of a cylindrical dual rotating electric toothbrush, according to a second embodiment of the technology described herein.

FIG. 13 illustrates a top plan view of a cylindrical dual rotating electric toothbrush with the bristle direction switch in a first position, according to an embodiment of the technology described herein.

FIG. 14 illustrates a top plan view of a cylindrical dual rotating electric toothbrush with the bristle direction switch in a second position, according to an embodiment of the technology described herein.

### DETAILED DESCRIPTION OF THE INVENTION

The technology described herein will now be described in detail with reference to at least one preferred embodiment thereof as illustrated in the accompanying drawings. In the following description, numerous specific details are set forth in order to provide a thorough understanding of the technology described herein. It will be apparent, however, to one skilled in the art, that the technology described herein may be practiced without some or all of these specific details. In other instances, well known operations have not been described in detail so not to unnecessarily obscure the technology described herein.

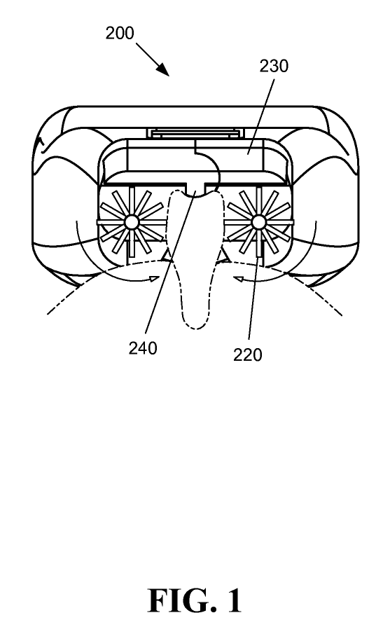

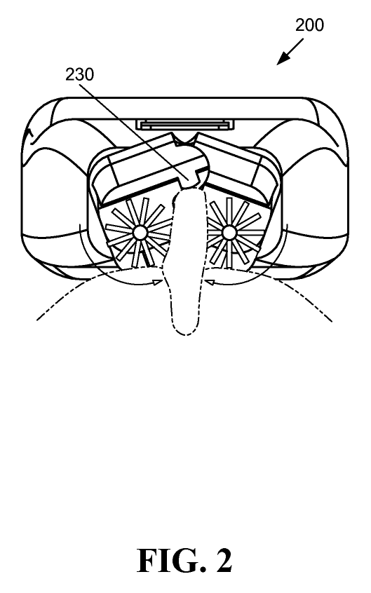

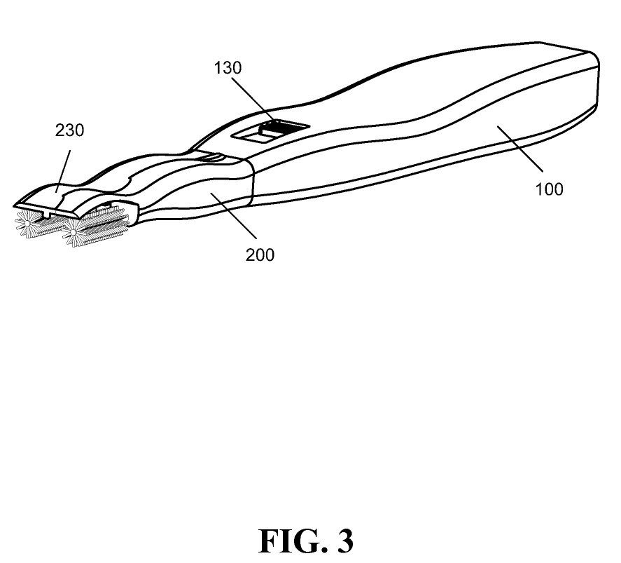

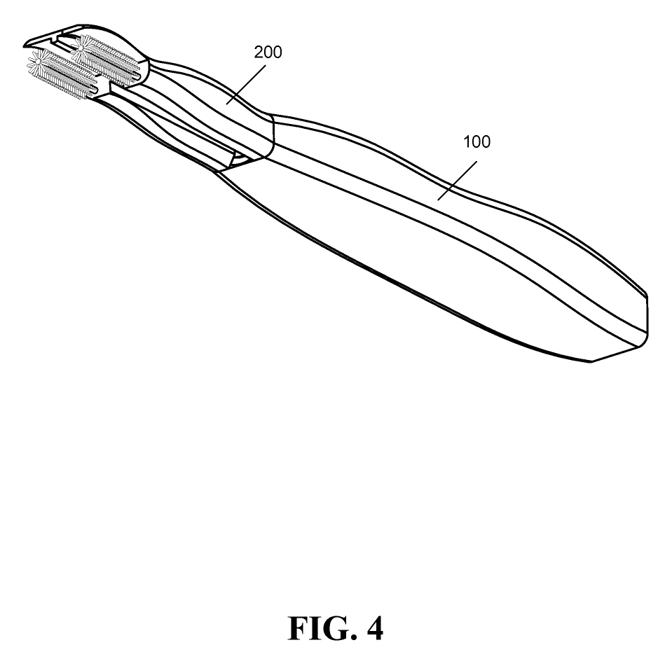

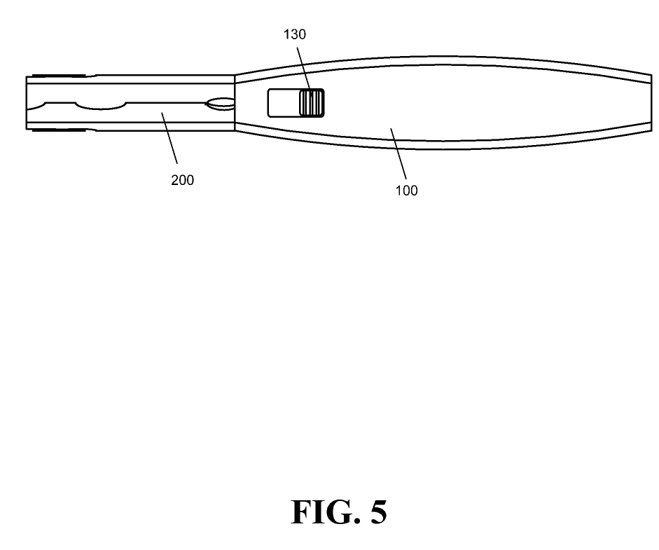

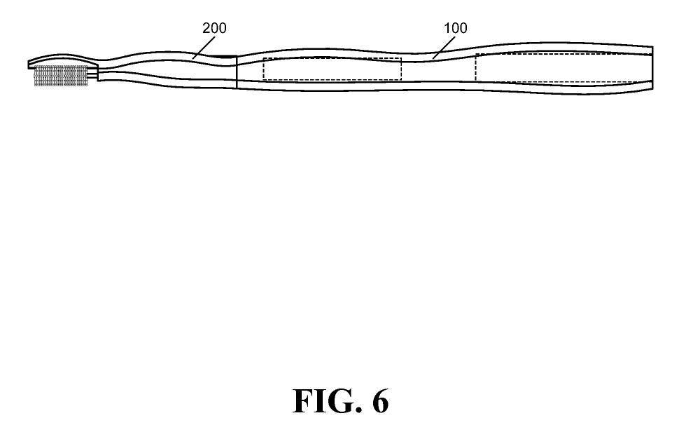

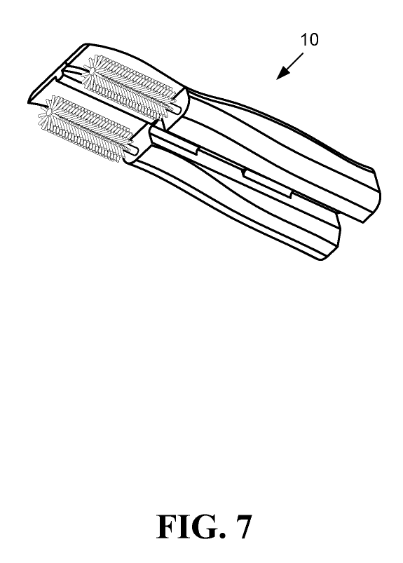

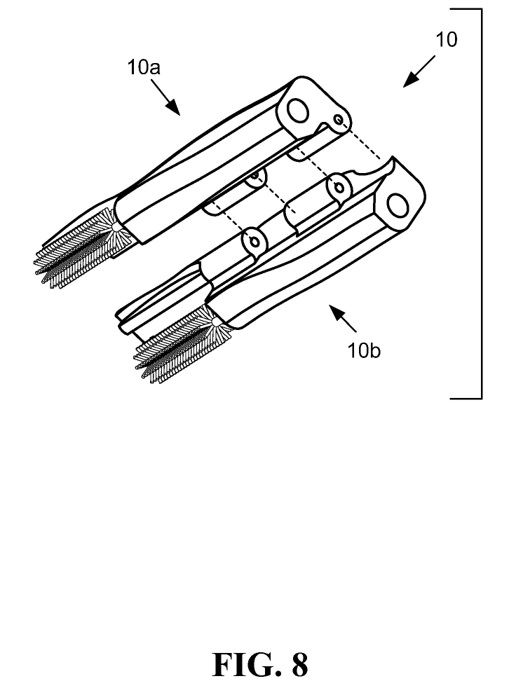

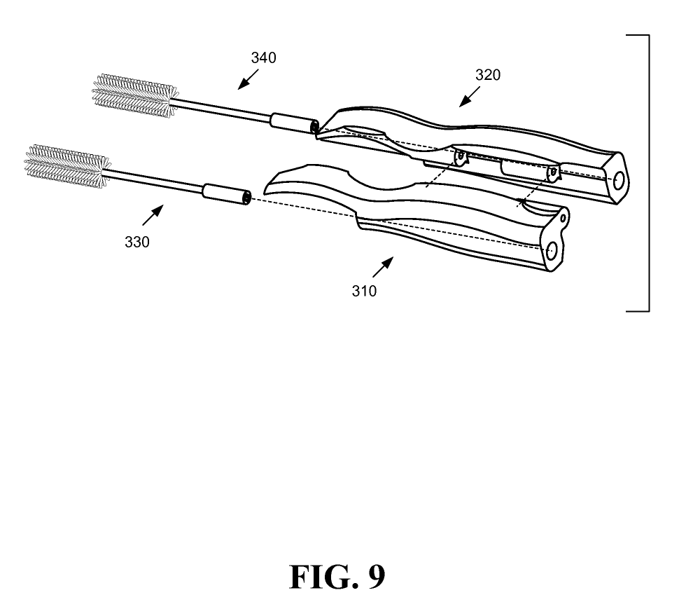

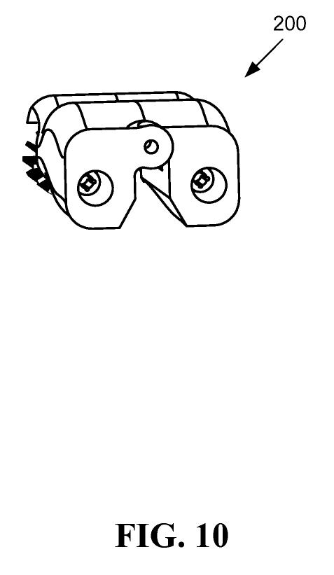

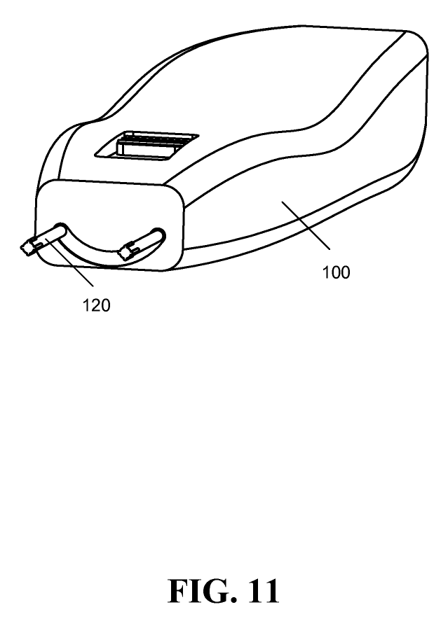

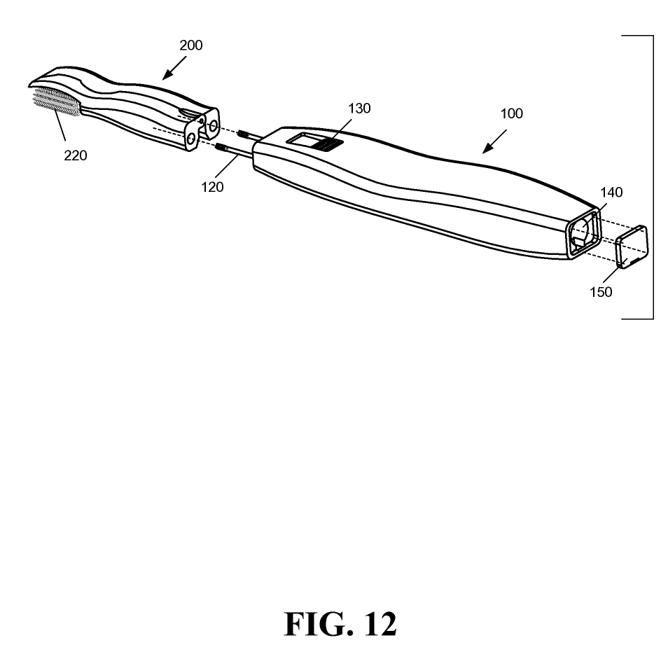

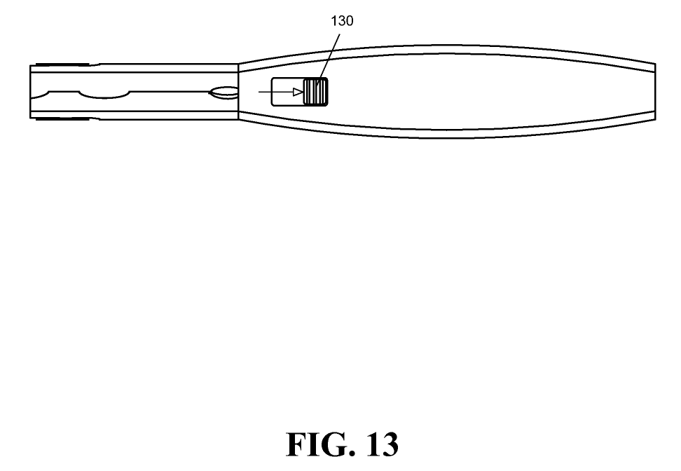

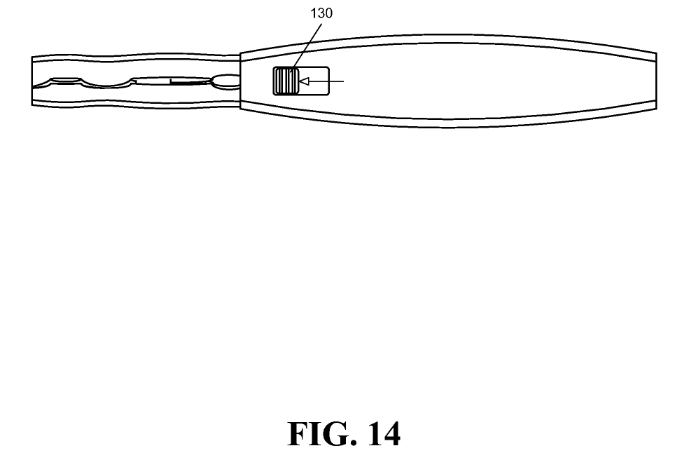

Referring to the drawings, FIGS. 1-14, where like reference numerals designate corresponding parts throughout the several figures, reference is made first to FIG. 1 which illustrates a head assembly 100.

The cylindrical dual rotating electric toothbrush 10 is comprised of a body assembly 100 and a head assembly 200. In an exemplary embodiment the body assembly is about 6-7 inches long, 0.75 inches thick and 1.5 inches in diameter of an oval shaped structure. The body assembly is further comprised of a motor and battery chamber 140 and batter chamber closure 150. At the front end of the body assembly 100, two of 0.5 inch long cylinders 120 stick out, which function as male parts when a user connects the head assembly 200 to the body assembly 100.

The head assembly 200 is about 3 inches long with about one inch of this being the head tip 210. This head assembly 200 can be connected to the body assembly 100 with a simple snap-in motion. The head tip 210 has an open area where two lines of bristles 220 are fixed to the wires or cylinders. The wires or cylinders are connected to a power source for rotation, once the switch 130 is positioned to complete the circuit. The wires or cylinders may be flexible, so that they can adjust to embrace different dimensions of the teeth. The dimension of the head tip is about 0.75 inch wide from a dorsal point of view and about 0.5 inch height from side view. Between the two lines of bristles, there is about 0.125 inch gap or space.

A head cover 230 covers the upper portion of the bristles 220 in order to protect the inner cheeks or lips of the user from unpleasant feelings or mechanical injury. At the tip of the brush head, in the middle of the two lines of bristles 220, there is prominent feature which works as guiding stop 240. With this guiding stop 240, a user has a higher probability of positioning the bristles 220 correctly.

From the ventral view of the head assembly, there is an opening not only for the one inch long head tip portion where actual brushing actions are performed but also for the second part of the head assembly 200, which is about two inches long, that is the size of 0.5 inch wide and 1.75 inch long. This space provides accommodation of the dentition for the user to position the brush tip in as correct of a position as possible. This feature make it possible to position the bristle line close to perpendicular to the long axis of a tooth.

In a second embodiment of the technology described herein, a cylindrical dual rotating electric toothbrush 10 is comprised of a left brush assembly 10a and a right brush assembly 10b. Each of these assemblies has a battery chamber, battery chamber closure, brush activation switch and corresponding circuitry. The left brush assembly 10a is comprised of a left body element 310 and a left brush element 220. The right brush assembly 10b is comprised of a right body element 320 and a right brush element 340.

The technology described herein may also be described as follows:

A mechanical teeth-cleaning device having two motorized lines of rotating brushes, the device comprising
a body defining a user handle, the body contoured to provide gripability, the body configured to contain a miniaturized motor to provide two shafts with counter-rotation and a battery chamber, the body having two protruding and substantially parallel, cylindrical, rotatable shafts mechanically coupled to the motor and configured to provide rotation each in a direction opposite to one another;
a head secured to the body, configured to connect to the body with a snap-in motion and mechanically coupled to the cylindrical, rotatable shafts;
a head tip containing two, generally parallel, rotating brushes exposed on their sides and undersides, the head tip located at the top of the head, each rotating brush being generally cylindrical and each connecting to one of the cylindrical, rotatable shafts, the rotating brushes configured for simultaneous contact with dentition, one with a buccal side and the other with a lingual side, and each rotating brush being separated one from another by a gap of a predetermined width and configured to correctly accommodate the dentition;
a guiding stop, located at a center, underside position of the head tip, configured to aid a user obtain a correct dentition placement position of the head tip and the brushes on one or more teeth; and
a cover portion on the head tip to provide a shielding protection between the rotating brushes and a cheek, tongue, or lip of a user, thereby preventing discomfort or injury to the user.

A mechanical teeth-cleaning device having two motorized lines of rotating brushes, the device comprising
a body defining a user handle, the body contoured to provide gripability, the body configured to contain a miniaturized motor to provide two shafts with counter-rotation and a battery chamber, the body having two protruding and substantially parallel, cylindrical, rotatable shafts mechanically coupled to the motor and configured to provide rotation each in a direction opposite to one another;
a head secured to the body, configured to connect to the body with a snap-in motion and mechanically coupled to the cylindrical, rotatable shafts;
a head tip containing two, generally parallel, rotating brushes exposed on their sides and undersides, the head tip located at the top of the head, each rotating brush being generally cylindrical and each connecting to one of the cylindrical, rotatable shafts, the rotating brushes configured for simultaneous contact with dentition, one with a buccal side and the other with a lingual side, and each rotating brush being separated one from another by a gap of a predetermined width and configured to correctly accommodate the dentition; and
a guiding stop, located at a center, underside position of the head tip, configured to aid a user obtain a correct dentition placement position of the head tip and the brushes on one or more teeth; where the head tip is hingedly divisible at a pivot-point location on an underside of the guiding stop, thereby narrowing the gap between the rotating brushes configured to correctly accommodate the dentition and thereby accommodating any of narrow or front teeth.

A mechanical teeth-cleaning device having two motorized lines of rotating brushes, the device comprising
a body defining a user handle, the body contoured to provide gripability, the body configured to contain a miniaturized motor to provide two shafts with counter-rotation and a battery chamber, the body having two protruding and substantially parallel, cylindrical, rotatable shafts mechanically coupled to the motor and configured to provide rotation each in a direction opposite to one another;
a head secured to the body, configured to connect to the body with a snap-in motion and mechanically coupled to the cylindrical, rotatable shafts;
a head tip containing two, generally parallel, rotating brushes exposed on their sides and undersides, the head tip located at the top of the head, each rotating brush being generally cylindrical and each connecting to one of the cylindrical, rotatable shafts, the rotating brushes configured for simultaneous contact with dentition, one with a buccal side and the other with a lingual side, and each rotating brush being separated one from another by a gap of a predetermined width and configured to correctly accommodate the dentition;
a guiding stop, located at a center, underside position of the head tip, configured to aid a user obtain a correct dentition placement position of the head tip and the brushes on one or more teeth;
a cover portion on the head tip to provide a shielding protection between the rotating brushes and a cheek, tongue, or lip of a user, thereby preventing discomfort or injury to the user: and,
a toggle switch located on the body of the mechanical teeth-cleaning device, the toggle switch configured to change between two predetermined width settings, thereby changing a width of the gap configured to correctly accommodate the dentition, where the toggle switch is configured to switch between two settings, one representing a width of front teeth and one representing a width of back teeth.

A mechanical teeth-cleaning device having two motorized lines of rotating brushes, the device comprising
a body defining a user handle, the body contoured to provide gripability, the body configured to contain a miniaturized motor to provide two shafts with counter-rotation and a battery chamber, the body having two protruding and substantially parallel, cylindrical, rotatable shafts mechanically coupled to the motor and configured to provide rotation each in a direction opposite to one another;
a head secured to the body, configured to connect to the body with a snap-in motion and mechanically coupled to the cylindrical, rotatable shafts;
a head tip containing two, generally parallel, rotating brushes exposed on their sides and undersides, the head tip located at the top of the head, each rotating brush being generally cylindrical and each connecting to one of the cylindrical, rotatable shafts, the rotating brushes configured for simultaneous contact with dentition, one with a buccal side and the other with a lingual side, and each rotating brush being separated one from another by a gap of a predetermined width and configured to correctly accommodate the dentition;
a guiding stop, located at a center, underside position of the head tip, configured to aid a user obtain a correct dentition placement position of the head tip and the brushes on one or more teeth; and
a cover portion on the head tip to provide a shielding protection between the rotating brushes and a cheek, tongue, or lip of a user, thereby preventing discomfort or injury to the user, where the motor of the mechanical teeth-cleaning device is configured to utilize and derive power from both an AC voltage source and a DC voltage source interchangeably.

A mechanical teeth-cleaning device having two motorized lines of rotating brushes, the device comprising
a body defining a user handle, the body contoured to provide gripability, the body configured to contain a miniaturized motor to provide two shafts with counter-rotation and a battery chamber, the body having two protruding and substantially parallel, cylindrical, rotatable shafts mechanically coupled to the motor and configured to provide rotation each in a direction opposite to one another;
a head secured to the body, configured to connect to the body with a snap-in motion and mechanically coupled to the cylindrical, rotatable shafts;
a head tip containing two, generally parallel, rotating brushes exposed on their sides and undersides, the head tip located at the top of the head, each rotating brush being generally cylindrical and each connecting to one of the cylindrical, rotatable shafts, the rotating brushes configured for simultaneous contact with dentition, one with a buccal side and the other with a lingual side, and each rotating brush being separated one from another by a gap of a predetermined width and configured to correctly accommodate the dentition;
a guiding stop, located at a center, underside position of the head tip, configured to aid a user obtain a correct dentition placement position of the head tip and the brushes on one or more teeth; and
a cover portion on the head tip to provide a shielding protection between the rotating brushes and a cheek, tongue, or lip of a user, thereby preventing discomfort or injury to the user, where the two, generally parallel, rotating brushes located in the head tip are configured to rotate in a direction from a gum area upwardly to a tooth area along a long axis of the tooth area to address cleaning an embrasure-space area located between two adjacent teeth and a gum line, and where the rotating brushes are configured to prevent gingival from detachment or retrocession.

A mechanical teeth-cleaning device having two motorized lines of rotating brushes, the device comprising
a body defining a user handle, the body contoured to provide gripability, the body configured to contain a miniaturized motor to provide two shafts with counter-rotation and a battery chamber, the body having two protruding and substantially parallel, cylindrical, rotatable shafts mechanically coupled to the motor and configured to provide rotation each in a direction opposite to one another;
a head secured to the body, configured to connect to the body with a snap-in motion and mechanically coupled to the cylindrical, rotatable shafts;
a head tip containing two, generally parallel, rotating brushes exposed on their sides and undersides, the head tip located at the top of the head, each rotating brush being generally cylindrical and each connecting to one of the cylindrical, rotatable shafts, the rotating brushes configured for simultaneous contact with dentition, one with a buccal side and the other with a lingual side, and each rotating brush being separated one from another by a gap of a predetermined width and configured to correctly accommodate the dentition;
a guiding stop, located at a center, underside position of the head tip, configured to aid a user obtain a correct dentition placement position of the head tip and the brushes on one or more teeth;
a cover portion on the head tip to provide a shielding protection between the rotating brushes and a cheek, tongue, or lip of a user, thereby preventing discomfort or injury to the user; and
one or more electrical sensors configured to automatically detect a width of one or more teeth and to automatically and continually adjust a width of the gap between the rotating brushes configured to correctly accommodate the dentition.

A mechanical teeth-cleaning device having two motorized lines of rotating brushes, the device comprising
a body defining a user handle, the body contoured to provide gripability, the body configured to contain a miniaturized motor to provide two shafts with counter-rotation and a battery chamber, the body having two protruding and substantially parallel, cylindrical, rotatable shafts mechanically coupled to the motor and configured to provide rotation each in a direction opposite to one another;
a head secured to the body, configured to connect to the body with a snap-in motion and mechanically coupled to the cylindrical, rotatable shafts;
a head tip containing two, generally parallel, rotating brushes exposed on their sides and undersides, the head tip located at the top of the head, each rotating brush being generally cylindrical and each connecting to one of the cylindrical, rotatable shafts, the rotating brushes configured for simultaneous contact with dentition, one with a buccal side and the other with a lingual side, and each rotating brush being separated one from another by a gap of a predetermined width and configured to correctly accommodate the dentition;
a guiding stop, located at a center, underside position of the head tip, configured to aid a user obtain a correct dentition placement position of the head tip and the brushes on one or more teeth; and
a cover portion on the head tip to provide a shielding protection between the rotating brushes and a cheek, tongue, or lip of a user, thereby preventing discomfort or injury to the user, where the rotating brushes further comprise bristles of varying lengths and diameters.

A mechanical teeth-cleaning device having two motorized lines of rotating brushes, the device comprising
a body defining a user handle, the body contoured to provide gripability, the body configured to contain a miniaturized motor to provide two shafts with counter-rotation and a battery chamber, the body having two protruding and substantially parallel, cylindrical, rotatable shafts mechanically coupled to the motor and configured to provide rotation each in a direction opposite to one another;
a head secured to the body, configured to connect to the body with a snap-in motion and mechanically coupled to the cylindrical, rotatable shafts;
a head tip containing two, generally parallel, rotating brushes exposed on their sides and undersides, the head tip located at the top of the head, each rotating brush being generally cylindrical and each connecting to one of the cylindrical, rotatable shafts, the rotating brushes configured for simultaneous contact with dentition, one with a buccal side and the other with a lingual side, and each rotating brush being separated one from another by a gap of a predetermined width and configured to correctly accommodate the dentition;
a guiding stop, located at a center, underside position of the head tip, configured to aid a user obtain a correct dentition placement position of the head tip and the brushes on one or more teeth; and
a cover portion on the head tip to provide a shielding protection between the rotating brushes and a cheek, tongue, or lip of a user, thereby preventing discomfort or injury to the user, where the cylindrical, rotatable shafts are comprised of a flexible material to bend as necessary to accommodate varying sizes of teeth.

A mechanical teeth-cleaning device having two motorized lines of rotating brushes, the device comprising
a body defining a user handle, the body contoured to provide gripability, the body configured to contain a miniaturized motor to provide two shafts with counter-rotation and a battery chamber, the body having two protruding and substantially parallel, cylindrical, rotatable shafts mechanically coupled to the motor and configured to provide rotation each in a direction opposite to one another;
a head secured to the body, configured to connect to the body with a snap-in motion and mechanically coupled to the cylindrical, rotatable shafts;
a head tip containing two, generally parallel, rotating brushes exposed on their sides and undersides, the head tip located at the top of the head, each rotating brush being generally cylindrical and each connecting to one of the cylindrical, rotatable shafts, the rotating brushes configured for simultaneous contact with dentition, one with a buccal side and the other with a lingual side, and each rotating brush being separated one from another by a gap of a predetermined width and configured to correctly accommodate the dentition;
a guiding stop, located at a center, underside position of the head tip, configured to aid a user obtain a correct dentition placement position of the head tip and the brushes on one or more teeth; and
a cover portion on the head tip to provide a shielding protection between the rotating brushes and a cheek, tongue, or lip of a user, thereby preventing discomfort or injury to the user, where the head of the mechanical teeth-cleaning device further comprises an opening located in a center portion of the head configured to provide space for dentition as the mechanical teeth-cleaning device is moved and rotated, thereby configured to provide correct positioning of a plurality of bristles generally perpendicular to a long axis of a tooth.

A method for manufacturing a mechanical teeth-cleaning device having two motorized lines of rotating brushes, the method comprising:
utilizing a body defining a user handle,
contouring the body to provide gripability,
configuring the body to contain a miniaturized motor to provide two shafts with counter-rotation and a battery chamber, the body having two protruding and substantially parallel, cylindrical, rotatable shafts mechanically coupled to the motor, configuring the cylindrical, rotatable shafts to provide rotation each in a direction opposite to one another;
utilizing a head secured to the body, configuring the head to connect to the body with a snap-in motion and mechanically coupling the head to the cylindrical, rotatable shafts;
utilizing a head tip containing two, generally parallel, rotating brushes, placing the head tip at the top of the head, each rotating brush being generally cylindrical and each connecting to one of the cylindrical, rotatable shafts, configuring the rotating brushes for simultaneous contact with dentition, one with a buccal side and the other with a lingual side, and separating each rotating brush one from another by a gap of a predetermined width, configuring the gap to correctly accommodate the dentition; and
utilizing a guiding stop, locating the guiding stop at a center, underside position of the head tip, configuring the guiding stop to aid a user obtain a correct dentition placement position of the head tip and the brushes on one or more teeth.

A method for manufacturing a mechanical teeth-cleaning device having two motorized lines of rotating brushes, the method comprising:
utilizing a body defining a user handle,
contouring the body to provide gripability,
configuring the body to contain a miniaturized motor to provide two shafts with counter-rotation and a battery chamber, the body having two protruding and substantially parallel, cylindrical, rotatable shafts mechanically coupled to the motor, configuring the cylindrical, rotatable shafts to provide rotation each in a direction opposite to one another;
utilizing a head secured to the body, configuring the head to connect to the body with a snap-in motion and mechanically coupling the head to the cylindrical, rotatable shafts;
utilizing a head tip containing two, generally parallel, rotating brushes, placing the head tip at the top of the head, each rotating brush being generally cylindrical and each connecting to one of the cylindrical, rotatable shafts, configuring the rotating brushes for simultaneous contact with dentition, one with a buccal side and the other with a lingual side, and separating each rotating brush one from another by a gap of a predetermined width, configuring the gap to correctly accommodate the dentition;
utilizing a guiding stop, locating the guiding stop at a center, underside position of the head tip, configuring the guiding stop to aid a user obtain a correct dentition placement position of the head tip and the brushes on one or more teeth; and
utilizing a cover portion on the head tip thereby providing a shielding protection between the rotating brushes and a cheek, tongue, or lip of a user, thereby preventing discomfort or injury to the user, where the head tip is hingedly divisible at a pivot-point location on an underside of the guiding stop, thereby narrowing the gap between the rotating brushes configured to correctly accommodate the dentition and thereby accommodating any of narrow or front teeth, or where the rotating brushes further comprise bristles of varying lengths and diameters, or where the cylindrical, rotatable shafts are comprised of a flexible material to bend as necessary to accommodate varying sizes of teeth.

A method for manufacturing a mechanical teeth-cleaning device having two motorized lines of rotating brushes, the method comprising:
utilizing a body defining a user handle,
contouring the body to provide gripability,
configuring the body to contain a miniaturized motor to provide two shafts with counter-rotation and a battery chamber, the body having two protruding and substantially parallel, cylindrical, rotatable shafts mechanically coupled to the motor, configuring the cylindrical, rotatable shafts to provide rotation each in a direction opposite to one another;
utilizing a head secured to the body, configuring the head to connect to the body with a snap-in motion and mechanically coupling the head to the cylindrical, rotatable shafts;
utilizing a head tip containing two, generally parallel, rotating brushes, placing the head tip at the top of the head, each rotating brush being generally cylindrical and each connecting to one of the cylindrical, rotatable shafts, configuring the rotating brushes for simultaneous contact with dentition, one with a buccal side and the other with a lingual side, and separating each rotating brush one from another by a gap of a predetermined width, configuring the gap to correctly accommodate the dentition;
utilizing a guiding stop, locating the guiding stop at a center, underside position of the head tip, configuring the guiding stop to aid a user obtain a correct dentition placement position of the head tip and the brushes on one or more teeth;
utilizing a cover portion on the head tip thereby providing a shielding protection between the rotating brushes and a cheek, tongue, or lip of a user, thereby preventing discomfort or injury to the user,
utilizing a toggle switch located on the body of the mechanical teeth-cleaning device; and
configuring the toggle switch to change between two predetermined width settings, thereby changing a width of the gap configured to correctly accommodate the dentition.

A method for manufacturing a mechanical teeth-cleaning device having two motorized lines of rotating brushes, the method comprising:
utilizing a body defining a user handle,
contouring the body to provide gripability,
configuring the body to contain a miniaturized motor to provide two shafts with counter-rotation and a battery chamber, the body having two protruding and substantially parallel, cylindrical, rotatable shafts mechanically coupled to the motor, configuring the cylindrical, rotatable shafts to provide rotation each in a direction opposite to one another;
utilizing a head secured to the body, configuring the head to connect to the body with a snap-in motion and mechanically coupling the head to the cylindrical, rotatable shafts;
utilizing a head tip containing two, generally parallel, rotating brushes, placing the head tip at the top of the head, each rotating brush being generally cylindrical and each connecting to one of the cylindrical, rotatable shafts, configuring the rotating brushes for simultaneous contact with dentition, one with a buccal side and the other with a lingual side, and separating each rotating brush one from another by a gap of a predetermined width, configuring the gap to correctly accommodate the dentition;
utilizing a guiding stop, locating the guiding stop at a center, underside position of the head tip, configuring the guiding stop to aid a user obtain a correct dentition placement position of the head tip and the brushes on one or more teeth;
utilizing a cover portion on the head tip thereby providing a shielding protection between the rotating brushes and a cheek, tongue, or lip of a user, thereby preventing discomfort or injury to the user,
utilizing a toggle switch located on the body of the mechanical teeth-cleaning device;
configuring the toggle switch to change between two predetermined width settings, thereby changing a width of the gap configured to correctly accommodate the dentition; and
configuring the toggle switch to switch between two settings, one representing a width of front teeth and one representing a width of back teeth.

A method for manufacturing a mechanical teeth-cleaning device having two motorized lines of rotating brushes, the method comprising:
utilizing a body defining a user handle,
contouring the body to provide gripability,
configuring the body to contain a miniaturized motor to provide two shafts with counter-rotation and a battery chamber, the body having two protruding and substantially parallel, cylindrical, rotatable shafts mechanically coupled to the motor, configuring the cylindrical, rotatable shafts to provide rotation each in a direction opposite to one another;
utilizing a head secured to the body, configuring the head to connect to the body with a snap-in motion and mechanically coupling the head to the cylindrical, rotatable shafts;
utilizing a head tip containing two, generally parallel, rotating brushes, placing the head tip at the top of the head, each rotating brush being generally cylindrical and each connecting to one of the cylindrical, rotatable shafts, configuring the rotating brushes for simultaneous contact with dentition, one with a buccal side and the other with a lingual side, and separating each rotating brush one from another by a gap of a predetermined width, configuring the gap to correctly accommodate the dentition;
utilizing a guiding stop, locating the guiding stop at a center, underside position of the head tip, configuring the guiding stop to aid a user obtain a correct dentition placement position of the head tip and the brushes on one or more teeth; and
configuring the motor of the mechanical teeth-cleaning device to utilize and derive power from both an AC voltage source and a DC voltage source interchangeably, or configuring the two, generally parallel, rotating brushes located in the head tip to rotate in a direction from a gum area upwardly to a tooth area along a long axis of the tooth area to address cleaning an embrasure-space area located between two adjacent teeth and a gum line, and where the rotating brushes are configured to prevent gingival from detachment or retrocession, or
utilizing one or more electrical sensors; and configuring the one or more electrical sensors to automatically detect a width of one or more teeth and to automatically and continually adjust a width of the gap between the rotating brushes configured to correctly accommodate the dentition; or
configuring the head of the mechanical teeth-cleaning device with an opening located in a center portion of the head configured to provide space for dentition as the mechanical teeth-cleaning device is moved and rotated, thereby configured to provide correct positioning of a plurality of bristles generally perpendicular to a long axis of a tooth.

The foregoing description and drawings comprise illustrative embodiments of the technology described herein. Having thus described exemplary embodiments of the technology described herein, it should be noted by those skilled in the art that the within disclosures are exemplary only, and that various other alternatives, adaptations and modifications may be made within the scope of the technology described herein. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing description and the associated drawings. Although specific terms may be employed herein, they are used in a generic and descriptive sense only and not for purposes of limitation. Accordingly, the technology described herein is not limited to the specific embodiments illustrated herein, but is limited only by the following claims.

What is claimed is:

1. A mechanical teeth-cleaning device having two motorized lines of rotating brushes, the device comprising:
a body defining a user handle, the body contoured to provide gripability, the body configured to contain a miniaturized motor to provide two shafts with counter-rotation and a battery chamber, the body having two protruding and substantially parallel, cylindrical, rotatable shafts mechanically coupled to the motor and configured to provide rotation each in a direction opposite to one another;
a head secured to the body, configured to connect to the body with a snap-in motion and mechanically coupled to the cylindrical, rotatable shafts;
a head tip containing two, generally parallel, rotating brushes exposed on their sides and undersides, the head tip located at the top of the head, each rotating brush being generally cylindrical and each connecting to one of the cylindrical, rotatable shafts, the rotating brushes configured for simultaneous contact with dentition, one with a buccal side and the other with a lingual side, and each rotating brush being separated one from another by a gap of a predetermined width and configured to correctly accommodate the dentition; and
a guiding stop, located at a center, underside position of the head tip, configured to aid a user obtain a correct dentition placement position of the head tip and the brushes on one or more teeth.

2. The mechanical teeth-cleaning device having two motorized lines of rotating brushes of claim 1, further comprising:
a cover portion on the head tip to provide a shielding protection between the rotating brushes and a cheek, tongue, or lip of a user, thereby preventing discomfort or injury to the user.

3. The mechanical teeth-cleaning device having two motorized lines of rotating brushes of claim 1, wherein the head tip is hingedly divisible at a pivot-point location on an underside of the guiding stop, thereby narrowing the gap between the rotating brushes configured to correctly accommodate the dentition and thereby accommodating any of narrow or front teeth.

4. The mechanical teeth-cleaning device having two motorized lines of rotating brushes of claim 1, further comprising:
a toggle switch located on the body of the mechanical teeth-cleaning device, the toggle switch configured to change between two predetermined width settings, thereby changing a width of the gap configured to correctly accommodate the dentition.

5. The mechanical teeth-cleaning device having two motorized lines of rotating brushes of claim 4, wherein the toggle switch is configured to switch between two settings, one representing a width of front teeth and one representing a width of back teeth.

6. The mechanical teeth-cleaning device having two motorized lines of rotating brushes of claim 1, wherein the motor of the mechanical teeth-cleaning device is configured to utilize and derive power from both an AC voltage source and a DC voltage source interchangeably.

7. The mechanical teeth-cleaning device having two motorized lines of rotating brushes of claim 1, wherein the two, generally parallel, rotating brushes located in the head tip are configured to rotate in a direction from a gum area upwardly to a tooth area along a long axis of the tooth area to address cleaning an embrasure-space area located between two adjacent teeth and a gum line, and wherein the rotating brushes are configured to prevent gingival from detachment or retrocession.

8. The mechanical teeth-cleaning device having two motorized lines of rotating brushes of claim 1, further comprising:
one or more electrical sensors configured to automatically detect a width of one or more teeth and to automatically and continually adjust a width of the gap between the rotating brushes configured to correctly accommodate the dentition.

9. The mechanical teeth-cleaning device having two motorized lines of rotating brushes of claim 1, wherein the rotating brushes further comprise bristles of varying lengths and diameters.

10. The mechanical teeth-cleaning device having two motorized lines of rotating brushes of claim 1, wherein the cylindrical, rotatable shafts are comprised of a flexible material to bend as necessary to accommodate varying sizes of teeth.

11. The mechanical teeth-cleaning device having two motorized lines of rotating brushes of claim 1, wherein the head of the mechanical teeth-cleaning device further comprises:
an opening located in a center portion of the head configured to provide space for dentition as the mechanical teeth-cleaning device is moved and rotated, thereby configured to provide correct positioning of a plurality of bristles generally perpendicular to a long axis of a tooth.

12. A method for manufacturing a mechanical teeth-cleaning device having two motorized lines of rotating brushes, the method comprising:
utilizing a body defining a user handle, contouring the body to provide gripability, configuring the body to contain a miniaturized motor to provide two shafts with counter-rotation and a battery chamber, the body having two protruding and substantially parallel, cylindrical, rotatable shafts mechanically coupled to the motor, configuring the cylindrical, rotatable shafts to provide rotation each in a direction opposite to one another;
utilizing a head secured to the body, configuring the head to connect to the body with a snap-in motion and mechanically coupling the head to the cylindrical, rotatable shafts;
utilizing a head tip containing two, generally parallel, rotating brushes, placing the head tip at the top of the head, each rotating brush being generally cylindrical and each connecting to one of the cylindrical, rotatable shafts, configuring the rotating brushes for simultaneous contact with dentition, one with a buccal side and the other with a lingual side, and separating each rotating brush one from another by a gap of a predetermined width, configuring the gap to correctly accommodate the dentition; and
utilizing a guiding stop, locating the guiding stop at a center, underside position of the head tip, configuring the guiding stop to aid a user obtain a correct dentition placement position of the head tip and the brushes on one or more teeth.

13. The method for manufacturing a mechanical teeth-cleaning device having two motorized lines of rotating brushes of claim 12, further comprising:
utilizing a cover portion on the head tip thereby providing a shielding protection between the rotating brushes and a cheek, tongue, or lip of a user, thereby preventing discomfort or injury to the user.

14. The method for manufacturing a mechanical teeth-cleaning device having two motorized lines of rotating brushes of claim 12, wherein the head tip is hingedly divisible at a pivot-point location on an underside of the guiding stop, thereby narrowing the gap between the rotating brushes configured to correctly accommodate the dentition and thereby accommodating any of narrow or front teeth.

15. The method for manufacturing a mechanical teeth-cleaning device having two motorized lines of rotating brushes of claim 12, further comprising:
utilizing a toggle switch located on the body of the mechanical teeth-cleaning device; and
configuring the toggle switch to change between two predetermined width settings, thereby changing a width of the gap configured to correctly accommodate the dentition.

16. The method for manufacturing a mechanical teeth-cleaning device having two motorized lines of rotating brushes of claim 15, further comprising:
configuring the toggle switch to switch between two settings, one representing a width of front teeth and one representing a width of back teeth.

17. The method for manufacturing a mechanical teeth-cleaning device having two motorized lines of rotating brushes of claim 12, further comprising:
configuring the motor of the mechanical teeth-cleaning device to utilize and derive power from both an AC voltage source and a DC voltage source interchangeably.

18. The method for manufacturing a mechanical teeth-cleaning device having two motorized lines of rotating brushes of claim 12, further comprising:
configuring the two, generally parallel, rotating brushes located in the head tip to rotate in a direction from a gum area upwardly to a tooth area along a long axis of the tooth area to address cleaning an embrasure-space area located between two adjacent teeth and a gum line, and wherein the rotating brushes are configured to prevent gingival from detachment or retrocession.

19. The method for manufacturing a mechanical teeth-cleaning device having two motorized lines of rotating brushes of claim 12, further comprising:
utilizing one or more electrical sensors; and
configuring the one or more electrical sensors to automatically detect a width of one or more teeth and to automatically and continually adjust a width of the gap between the rotating brushes configured to correctly accommodate the dentition.

20. The method for manufacturing a mechanical teeth-cleaning device having two motorized lines of rotating brushes of claim 12, wherein the rotating brushes further comprise bristles of varying lengths and diameters.

21. The method for manufacturing a mechanical teeth-cleaning device having two motorized lines of rotating brushes of claim 12, wherein the cylindrical, rotatable shafts are comprised of a flexible material to bend as necessary to accommodate varying sizes of teeth.

22. The method for manufacturing a mechanical teeth-cleaning device having two motorized lines of rotating brushes of claim 12, further comprising:
configuring the head of the mechanical teeth-cleaning device with an opening located in a center portion of the head configured to provide space for dentition as the mechanical teeth-cleaning device is moved and rotated, thereby configured to provide correct positioning of a plurality of bristles generally perpendicular to a long axis of a tooth.
